(19) United States
(12) Patent Application Publication
(10) Pub. No.: US 2007/0096069 A1
(43) Pub. Date: May 3, 2007

(54) Motorcycle rear stand

(75) Inventors: Alfred J. Kobacker II, Blacklick, OH (US); Gary P. Zimmerman, Pataskala, OH (US)

Correspondence Address: Thomas S. Baker, Jr., 1371 West 3rd Avenue, Columbus, OH, 43212, US

(73) Assignee: Ideanamcis, LLC

(21) Appl. No.: 11/641,130

(22) Filed: Dec. 19, 2006

Related U.S. Application Data
(62) Division of application No. 11/042,425, filed on Jan. 25, 2005.

(51) Int. Cl. B66F 3/00

(52) U.S. Cl. 254/131

(57) ABSTRACT

A motorcycle rear stand for lifting the rear end of a motorcycle having a rear end lift pivot member and supported on a kickstand having a frame with a pair of side support members, a stop surface at one end of the frame, a pivot mounted at different distances forwardly of the stop surface on each of the side members, a lift arm having a bike engagement member at its outer end mounted on the frame and projecting upwardly therefrom wherein pivotal movement of the frame simultaneously lifts the rear end of a motorcycle and levels the motorcycle from an initial leaning position.

### BACKGROUND OF THE INVENTION

A motorcycle rear stand functions to move the rear end of a motorcycle between a first position in which both wheels of the motorcycle are on the ground and a second position in which the rear end of the motorcycle including the rear wheel are elevated above the ground. A problem associated with motorcycle rear stands is that motorcycles normally are retained in an upright position by a kickstand, which causes the motorcycle to lean over in the direction of the kickstand. One prior art motorcycle rear stand has a pair of spaced L-shaped side bars with wheels mounted at the vertex of the side bars and V- or U-shaped bike engagement members at the outer ends of the side bars, adapted to engage opposite sides of a motorcycle rear axle. The L-shaped side bars are connected by a U-shaped member which joins the upper ends of the side bars and attaches to the bases of the L-shaped side bars to thereby interconnect the side bars and to space them a fixed distance equal to the distance between opposite sides of the motorcycle rear axle. A handle member attaches to the ends of the L-shaped side bars remote from the bike engagement members.

In order to use the prior art motorcycle rear stand, the U- or V-shaped bike engagement members are aligned in close proximity to the rear axle projections on opposite sides of the motorcycle prior to lifting the rear end of the motorcycle.

Because a motorcycle leans at an angle such that the vertical axis of the motorcycle is not perpendicular to the ground when the cycle is supported on a kickstand, the prior art motorcycle rear stand cannot properly align the bike engagement members with the rear axle projections on opposite sides of the motorcycle prior to lifting the bike inasmuch as the angled position of the motorcycle causes the rear wheel axle projection on the kickstand side of the motorcycle to be lower in elevation above the ground than the motorcycle rear axle projection on the opposite side of the motorcycle. Consequently, the prior art rear stand cannot commence to elevate the rear of a motorcycle on a kickstand because it can securely engage only the lower, kickstand side axle projection and has little or no control over the opposite rear wheel axle projection. Lifting the motorcycle in this condition could cause it to tip over.

To remedy this situation, a user typically inserts a shim, which may be a block of wood, between the base of the kickstand and the ground to thereby move the leaning, vertical off-center motorcycle to a nearly vertical position. After this has been accomplished, the U- or V-shaped bike engagement members at the ends of the L-shaped side bars can be aligned with the motorcycle rear wheel axle projections on both sides of the motorcycle to thereby lift the motorcycle rear wheel from the ground. In order to safely return the rear end of the motorcycle to the ground, extreme caution must be exercised to ensure that the base of the kickstand engages the shim as the motorcycle is lowered to ensure that the rear stand user can retain control of the motorcycle. Thereafter, the shim must be removed and the motorcycle leaned onto the kickstand.

Some motorcycles have rear suspensions which utilize a single swing arm and have rear wheel axles which have a central axial bore. Preferably these motorcycles are lifted by means of a pin inserted into the axle bore. When these motorcycles are supported on a kickstand, the axis of the rear wheel is non-parallel to the ground, making it difficult for a pin on a rear stand to engage the axle bore.

The instant invention solves the problem of lifting a motorcycle leaning on a kickstand from the ground, to a position with the rear wheel spaced from the ground and the motorcycle in a nearly vertical condition and thereafter returning the vehicle rear end to the ground and leaning the motorcycle back onto its kickstand while retaining control of the motorcycle at all times.

### SUMMARY OF THE INVENTION

A motorcycle rear stand for lifting the rear end of a motorcycle having a pair of rear end lift pivot points and supported on a kickstand having first and second lift arms having inner and outer ends and a connector member connecting the first and second lift arms. Bike engagement members at the outer ends of each of the first and second lift arms are adapted to pivotally engage one side of a pair of motorcycle rear end lift pivot points. A side support member having a base member at one end and a pivot connection at the opposite end is connected pivotally to the outer end of the first lift arm to thereby enable the first and second lift arms to pivot relative to the side support members when the handle is moved.

A method of lifting the rear end of a motorcycle having a pair of rear end lift pivot points and supported on a kickstand from a parked position on a lifting surface where the rear wheel axle axis is angled relative to the lifting surface to a position where the rear end of the motorcycle is elevated above the lifting surface and the rear wheel axle axis is parallel to the lifting surface comprises the steps of aligning first and second bike engagement members mounted on respective first and second lift arms with a pair of motorcycle rear end lift pivots and moving one end of the lift arms in a downward arc to cause the first lift arm to rotate about a side support member pivot and a corresponding lift arm bike engagement member to rotate upwardly in a fixed radius arc, thereby lifting one side of the motorcycle while simultaneously causing a second lift arm to move upwardly about a lower lift arm support pivot while rotating about the side member pivot axis, causing the second lift arm bike engagement member to move upwardly to lift the other side of the motorcycle and simultaneously causing the first and second lift arms to pivot transversely about the base of the side support member causing both sides of the motorcycle to be elevated above the lifting surface to a secured position.

A motorcycle rear stand for lifting the rear end of a motorcycle having a rear end lift pivot member and supported on a kickstand has a support frame with a stop surface at one end of the frame. A first pivot is on one side of the frame positioned forwardly of the stop surface a first distance, and a second pivot is on the other side of the frame forwardly of the stop surface a second distance. A lift arm is mounted on the frame projecting upwardly therefrom and a bike engagement member is attached to the outer end of the lift arm.

### BRIEF DESCRIPTION OF THE DRAWINGS

FIG. 1 is a right side view of a motorcycle supported on a kickstand showing the first embodiment of the motorcycle rear stand of the instant invention positioned behind the motorcycle;

FIG. 2 is a right side elevational view of the motorcycle rear stand of the instant invention in its aligned position with the rear end of the motorcycle shown in phantom;

FIG. 3 is a front view of FIG. 2;

FIG. 4 is a left side elevational view of the motorcycle rear stand shown with the rear end of the motorcycle in a lifted position;

FIG. 5 is a front view of FIG. 4;

FIG. 6 is a view similar to FIG. 5 of an alternate embodiment of the invention shown with motorcycle swing arm lift pins functioning as bike engagement pivot points and a tubular lateral pivot at the bottom of a side support member;

FIG. 7 is a right side elevational view of the embodiment depicted in FIG. 6 with the motorcycle rear stand in an aligned position;

FIG. 8 is a perspective new of a further embodiment of a motorcycle rear stand adapted to lift a motorcycle supported on a kickstand having a hollow rear axle;

FIG. 9 is a left side view of the rear stand of FIG. 8 shown engaged with the hollow rear axle of a rear wheel of a motorcycle in a lowered position;

FIG. 10 is a rear view of the rear stand as shown in FIG. 9;

FIG. 11 is a left side view of the rear stand of FIG. 8 shown engaged with the hollow rear axle of a rear wheel of a motorcycle in a lifted position; and

FIG. 12 is a rear view of the rear stand depicted in FIG. 11.

### DETAILED DESCRIPTION OF THE INVENTION

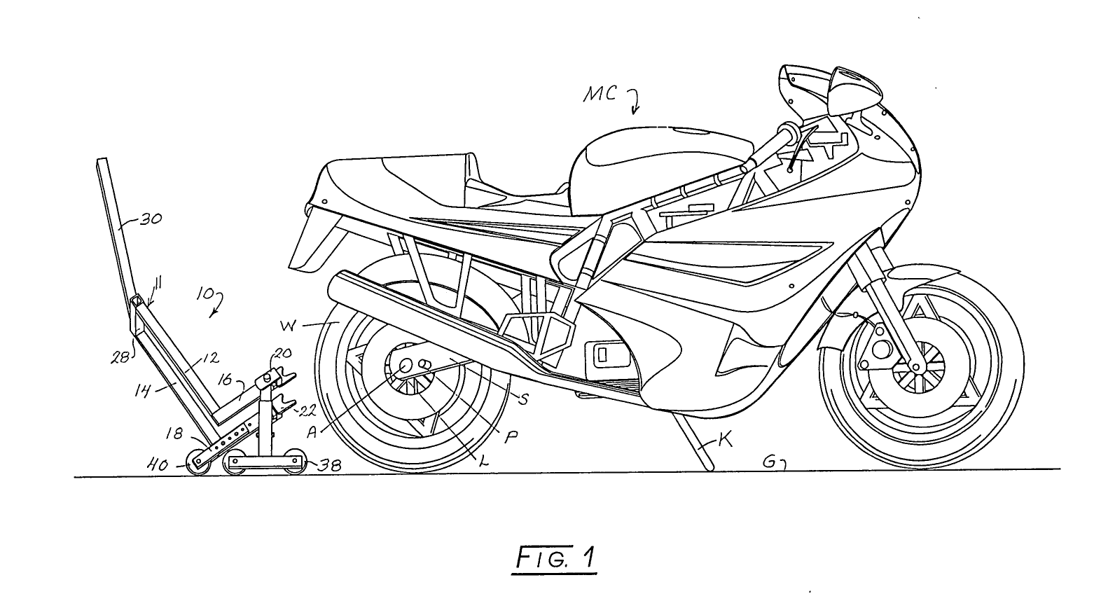

FIG. 1 shows a motorcycle MC supported on a kickstand K which projects from the lower, central portion of the left side of the motorcycle to a lifting surface or ground G. The rear end of the motorcycle has a rear wheel W mounted on an axle A which is supported in and projects from opposite sides of frame mounted swing arms S on opposite sides of the rear wheel W. The swing arms S have laterally projecting lift pivot points which may be pins P or lower lift arm surfaces L adapted to be engaged by bike engagement members mounted on a motorcycle rear stand 10 of the instant invention and described in detail herein below. Opposite ends of axle A also function as lift pivot points.

Referring to FIGS. 1 through 5 of the drawings, it may be seen that motorcycle rear stand 10 has a frame 11 comprising a pair of spaced legs 12 and 14, each having distal ends 12′ and 14′ and proximal ends 12″ and 14″. Lift arms 16 and 18 having inner ends 16′ and 18′ and outer ends 16″ and 18″ respectively are attached at substantially right angles to motorcycle rear stand legs 12 and 14 by having their inner ends 16′ and 18′ affixed as by welding to leg distal ends 12′ and 14′. It should be noted that the legs 12 and 14 and respective lift arms 16 and 18 may be formed as integral unitary elements. This description will refer to legs 12 and 14 and lift arms 16 and 18 as separate elements.

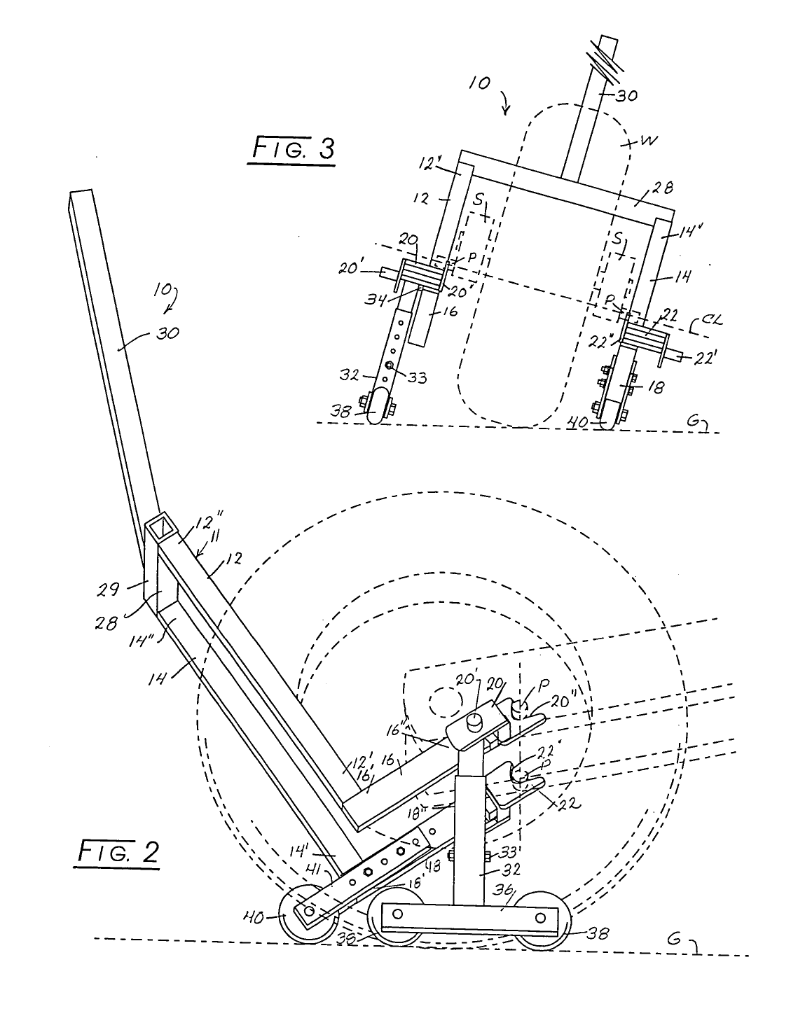

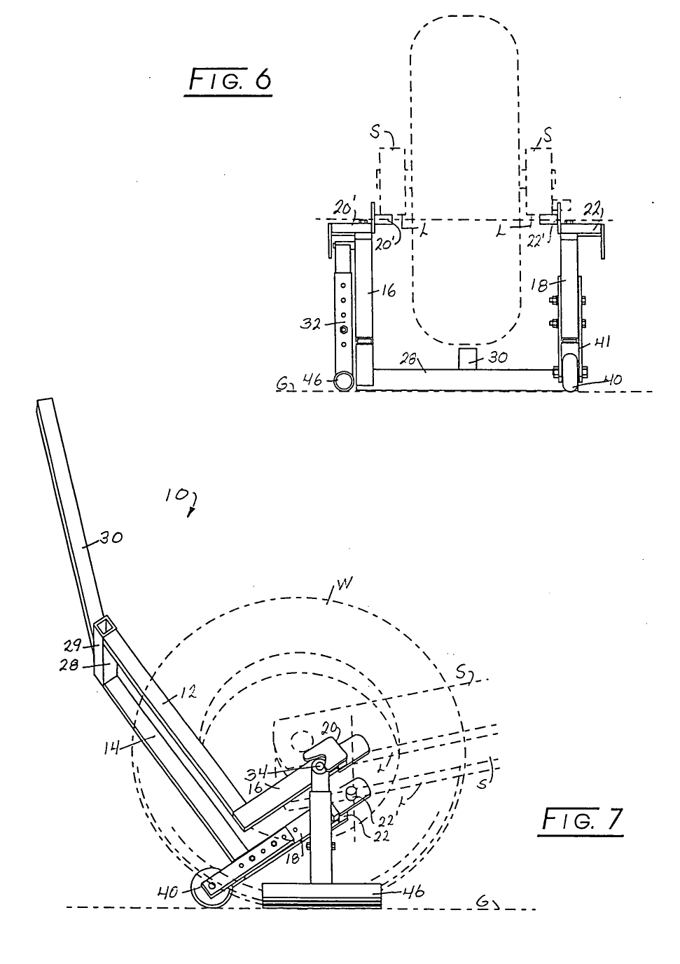

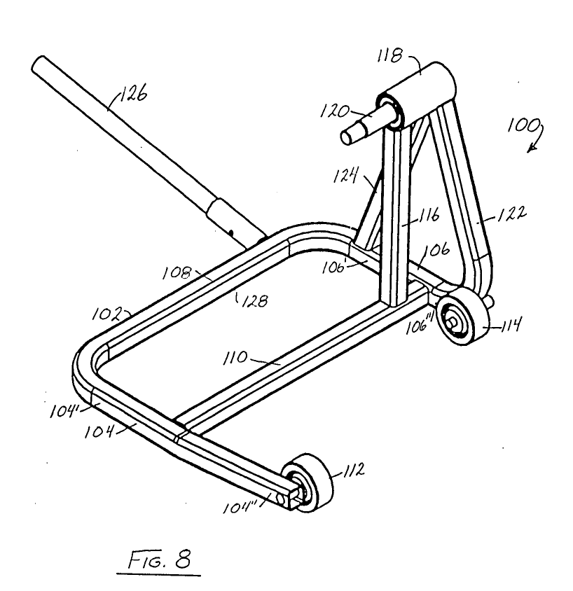

Bike engagement members 20 and 22 are attached to the lift arm outer ends 16″ and 18″ by threaded fasteners 24 which pass through elongated slots, not shown, in the members 20 and 22. The slots provide a lateral adjustment for member 20 and 22. The bike engagement members 20 and 22 have laterally projecting pins 20′ and 22′ at one side thereof and U- or V-shaped recessed openings 20″ and 22″ at the opposite side thereof. The bike engagement members 20 and 22 are adapted to be rotated about the fasteners 24 such that pins 20′ and 22′ are utilized when the motorcycle rear stand 10 is used in connection with a motorcycle MC where swing arm lower lift arm surfaces L function as the motorcycle rear end lift pivot points as depicted in FIGS. 6 and 7, and the U- or V-shaped recessed openings 20″ and 22″ are utilized when the motorcycle rear stand 10 is used in connection with a motorcycle where the rear end lift pivot points consist of lateral pins P projecting from motorcycle swing arms as depicted in FIGS. 2 through 5. The U- or V-shaped recessed openings 20″ and 22″ of the bike engagement members 20 and 22 also would be utilized where the motorcycle rear stand 10 engages end portions of the rear wheel axle which function as motorcycle rear end lift pivot points.

A lateral brace 28 is attached such as by welding to leg proximal ends 12″ and 14″ to securely connect legs 12 and 14 and lift arms 16 and 18 and to provide the proper spacing for the bike engagement members 20 and 22 of lift arms 16 and 18. A central, longitudinally extending hand engagement member or handle 30 extends upwardly from lateral brace 28 of motorcycle rear stand 10. Lateral brace 28 alone or in combination with hand engagement member 30 functions to move legs 12 and 14 between raised or lowered positions as described herein below. The bottom surface 29 of lateral brace 28 functions as a stop or stop surface. The frame would not need separate handle member 30 or lateral brace 28 if proximal ends 12″ and 14″ of the legs 12 and 14 were joined together. In this instance the proximal ends 12″ and 14″ of the legs 12 and 14 could function both as a brace 28 and as a handle 30. Additionally, although not shown, a lateral brace alone could act as a frame member or connector to directly connect the inner ends 16′ and 18′ of lift arms 16 and 18.

Motorcycle rear stand 10 is supported on one side by a telescoping side support member 32 having a laterally extending pivot or pivot member 34 which is rigidly secured to the outer end 16″of lift arm 16. Pivot member 34 may be a pin which engages an opening in lift arm 16 or a tube which receives a pin which projects laterally from lift arm outer end 16″ or any similar functioning member. The length of telescoping side support member 32 may be adjusted by inserting fasteners 33 in various combinations of aligned bores formed in the side support telescoping members. A generally horizontal or longitudinally extending base member 36 having a bottom surface lateral pivot which may be a wheel 38 at each end thereof is affixed to the bottom of side support member 32. From the above, it may be seen that lift arm 16 is pivotally mounted and rotatable about pivot member 34 on side support member 32 and that as lift arm 16 rotates, bike engagement member 20 at the outer end thereof also rotates upwardly or downwardly depending upon the rotation direction of lift arm 16.

A lower support element which may be a rotatable member and which acts as a pivot such as a bracket-mounted wheel 40 is attached to the inner end 18′ of lift arm 18 by fasteners 42 which pass through aligned openings in the bracket 41 and in lift arm 18. Wheel bracket 41 and the inner end 18′ of lift arm 18 have a plurality of spaced bores. Thus, the length of lift arm 18 and its associated pivotal lower support element 40 may be adjusted by selecting different bore combinations in wheel support bracket 41 and lift arm 18. This enables the length of lift arm 18 and its associated bike engagement member 22 to be adjusted. In a similar manner, the length of telescoping side support member 32 may be adjusted as mentioned above to effectively change the length of lift arm 16 supported thereon and its associated bike engagement member 20. Adjusting the length of lift arms 16 and 18 enables motorcycle rear stand 10 to accommodate and safely lift a motorcycle supported on a kickstand leaning at an angle with respect to lifting surface G as illustrated in FIGS. 1 through 3.

Prior to operating motorcycle rear stand 10 to lift a motorcycle MC, the legs 12 and 14 and the inner ends 16′ and 18′ of the lift arms 16 and 18 are raised or rotated to a full upright position as depicted in FIGS. 1 through 3 and the motorcycle rear stand 10 is moved in close proximity to the motorcycle rear end lift pivot points, which are illustrated as laterally projected pins P affixed to the lower ends of a pair of motorcycle swing arms S mounted on opposite sides of the motorcycle. Of course, as mentioned above, the motorcycle rear end lift pivot points also may be rear axle ends A which, like lateral pins P, are accommodated in the recessed openings 20″ and 22″ of bike engagement members 20 and 22. Alternatively, bike engagement member lateral pins 20′ and 22′ may be used to engage the lower surfaces L of the motorcycle swing arms which also act as rear end lift pivot points. Subsequent to the motorcycle rear stand 10 being moved such that bike engagement members 20 and 22 are in close proximity to swing arm lateral pins P, the length of telescoping side support member 32 is adjusted such that lateral pin P is received within bike engagement member recessed opening 20″ as illustrated in FIG. 2. Similarly, wheel support bracket 41 is adjusted at the inner end 18′ of lift arm 18 such that the laterally projecting pin P on the kickstand side of the bike is received within bike engagement member 22′ of lift arm 18, also illustrated in FIG. 2. In this position, the motorcycle is leaning on the kickstand at an angle with respect to lifting surface G as noted by the angled dotted line CL representing the centerline of the motorcycle rear axle in FIG. 3. Additionally, in this position, the lift arms 16 and 18 and their respective legs 12 and 14 on opposite sides of the rear stand 10 frame are raised from the lift surface G, and pivot member or wheel 40 at the inner end 18′ of lift arm 18 is behind wheels 38 which support telescoping side support member 32, as the rear stand 10 is viewed from the side as shown in FIG. 2.

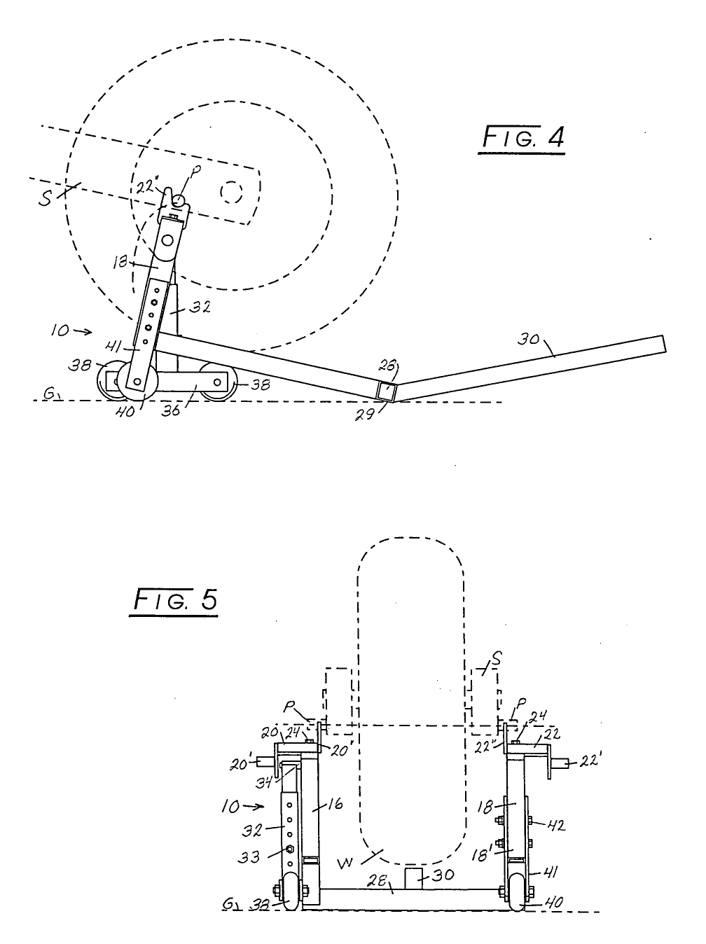

As frame legs 12 and 14 and the inner ends 16′ and 18′ of lift arms 16 and 18 are moved downwardly toward lifting surface G several things occur simultaneously. Bike engagement members 20 and 22 at the outer ends of lift arms 16 and 18 rotate upwardly in a counterclockwise arc, as viewed in FIGS. 1 and 2, about telescoping side support member pivot 34, and the kickstand side lift arm 18 moves upwardly as lower support element (wheel pivot 40) is moved rightwardly, as viewed in FIGS. 1 and 2. Lift arm 18 and its associated bike engagement member 22 are free to move upwardly from a position lower in height than that of the bike engagement member 20 on arm 16 adjacent side support member 32 to a position in which lift arm bike engagement member 22 is substantially equal in height to that of bike engagement member 20 of lift arm 16 because lift arm 18 is not constrained from vertical movement by pivot member 34 of side support member 32 as is lift arm 16 which is directly connected to pivot member 34. In order to accomplish this, as the lift arms 16 and 18 are rotating and lift arm 18 is moving upwardly, the motorcycle rear stand assembly 10 must pivot laterally about a lateral pivot surface of base member 36 (the outer surfaces of wheels 38) and the outer surface of pivot wheel 40 to cause telescoping side support member 32 to assume a vertical orientation with respect to lifting surface G, as illustrated in FIGS. 4 and 5. It may be seen that when the stop 29 of hand engagement member 28, 30 engages lifting surface G, frame legs 12 and 14 are lowered in close proximity to lift surface G, bike engagement members 20 and 22 are at a maximum elevation above lift surface G and pivot wheel 40 is moved from a position remote from or to the rear of wheels 38 of side support base member 36, as illustrated in FIG. 2, to a position in which it is between wheels 38 of base member 36. As viewed in FIG. 4, wheel pivot 40 has moved from a position to the right of the right most wheel 38 of base member 36 to a position between the base member wheels 38.

Additionally, referring again to FIG. 4, it may be seen that in this position of lift arms 16 and 18, the outer end 18″ of lift arm 18, bike engagement member 22″ and pin P have rotated over center, i.e., bike engagement member 22″ and pin P have rotated from about the 10 o'clock position to about the 1 o'clock position with respect to side support pivot member 34 as viewed in FIG. 4. Although not shown, bike engagement member 20″ of lift arm 16 and the lateral pin P captured thereby also have moved over center to secure the elevated motorcycle rear end in a stable position above the ground, as illustrated in FIG. 5. In this position, the center line CL of the motorcycle rear axle and lateral rear pins P are substantially parallel with lifting surface G.

In order to again lower the rear end of motorcycle MC to the ground, legs 12 and 14 and the inner ends 16′ and 18′ of lift arms 16 and 18 of the motorcycle rear stand 10 are raised from lift surface G or pivoted counterclockwise from the lifted position, as illustrated in FIG. 4, or clockwise to the motorcycle lowered position, as illustrated in FIG. 2. As legs 12 and 14 and the inner ends 16′ and 18′ of lift arms 16 and 18 are raised, the lower support element or pivot wheel 40 at the inner end of lift arm 18 is moved to the right, as illustrated in FIG. 4, or to the left, as illustrated in FIG. 2. As this occurs, lift arm 18 moves downwardly and the motorcycle rear stand 10 pivots laterally about the outer surface of wheels 38 at the lower end of base member 36 and the outer surface of pivot wheel 40 at the inner end 18′ of lift arm 18. At the same time, the bike engagement members 20 and 22 at the outer end of lift arms 16 and 18 rotate downwardly in an arc about side support pivot member 34. This action continues until the motorcycle rear wheel and kickstand engage the lifting surface G. In this position, the pivot axis of the bike engagement members 20 and 22 is angled and at a minimum elevation above the lifting surface G.

From the above, it may be seen that during pivotal movement of legs 12 and 14 and lift arms 16 and 18 of motorcycle rear stand 10 in either direction several things occur simultaneously. The bike engagement members 20 and 22 at the outer ends of the lift arms 16 and 18 rotate in an arc about pivot member 34 of side support member 32 and kickstand side lift arm 18 moves upward or downward. Also, the motorcycle rear stand 10 pivots laterally about the lateral pivot surface on the bottom of side support base member 36 and about the lower support element (wheel pivot 40) at the inner end of the kickstand side lift arm 18.

FIGS. 6 and 7 depict an alternate embodiment of a lateral pivot surface on the bottom of side support base member 36. In this embodiment, a longitudinally extending base member 46 affixed to the bottom of telescoping side support member 32 is illustrated as a tube having an curved bottom surface as opposed to a longitudinal member having a pair of wheels. The tube 46 functions in the same manner as the wheels 38 in that it allows lateral pivotal movement of the motorcycle rear stand 10 assembly when hand engagement member 28, 30 is moved between the vertical upright and the horizontal ground engagement positions.

Another embodiment of the instant invention is depicted in FIGS. 8 through 12. These Figures illustrate a motorcycle rear stand 100 adapted to be utilized in connection with lifting the rear end of a motorcycle having a single swing arm rear suspension member and a rear wheel axle A′ having a central axial bore formed therein. Rear stand 100 has a generally U-shaped frame 102 partially defined by a pair of unequal length side members 104 and 106 each having a proximal end 104′ and 106′ and a distal end 104″ and 106″. From the drawings, it is apparent that side member 104 is longer than side member 106. A lateral member 108 connects the proximal ends 104′ and 106′ of the side members 104 and 106 to form the generally U-shaped frame. A lateral reinforcing brace 110 extends parallel to lateral member 108 and connects to side members 104 and 106. Pivots 112 and 114 are affixed to the distal ends 104″ and 106″ of the side members 104 and 106. Although pivots 112 and 114 are shown as wheels, they may be rollers, bearings, or any other low friction member capable of acting as pivots for rear stand 100.

A lift arm 116 extends upwardly from frame 102 adjacent side member 106 which is the shorter of the two side members 104 and 106. Lift arm 116 also may be mounted directly on side member 106. A bike engagement member 118 having a laterally extending pin 120 is mounted at the outer end of lift arm 116. A pair of reinforcing arms 122 and 124 extend upwardly from frame 102 to assist lift arm 116 in supporting bike engagement member 118. With the proper choice of geometry and materials, reinforcing arms 122 and 124 would not be necessary.

A hand engagement member or handle 126 projects rearwardly and somewhat upwardly from the rear of frame 102. A stop surface 128 is formed on the bottom of lateral member 108. When stop surface 128 and pivots 112 and 114 engage the ground or other lift surface G′, the outer end of hand engagement member 126 is somewhat above the lift surface.

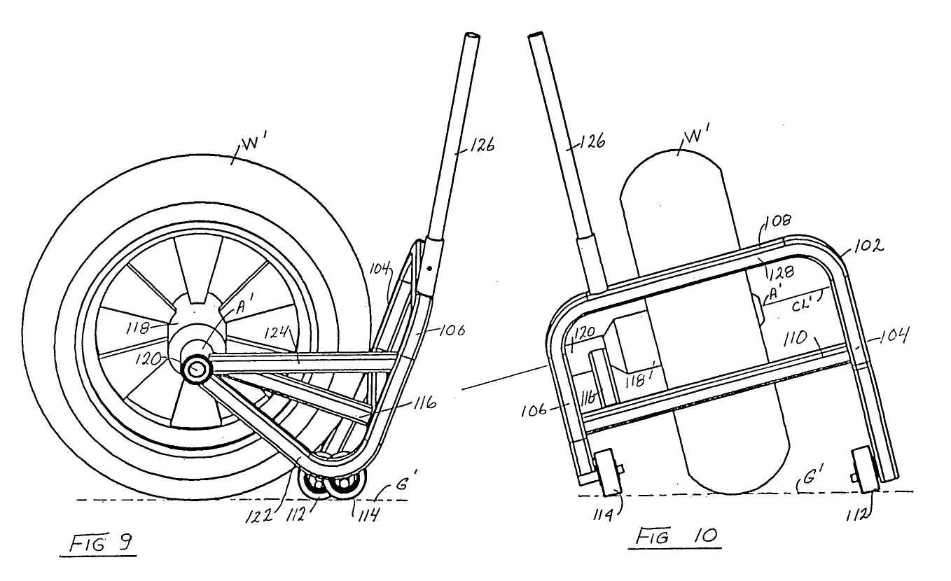

As mentioned above, motorcycle rear stand 100 is utilized to lift the motorcycle having a rear suspension with a single swing arm S′ and an axle A′ having a central longitudinally extending axial bore formed therein where the motorcycle is supported on a kickstand mounted centrally on the left side thereof. In this position of the motorcycle, the center line CL′ of the rear wheel axle A′ is angled with respect to the ground or lift surface G′ as best shown in FIG. 10. In order to cause the frame-mounted bike engagement member 118 and its associated pin 120 of motorcycle rear stand 100 to enter the longitudinally extending bore of axle A′, bike engagement member 118 must be lowered and the rear stand 100 tilted to cause the axis of the bike engagement member pin 120 to become aligned with the axis of the bore of axle A′. To accomplish this, handle 126 is raised such that stop surface 128 is moved away from the lift surface G′ and the motorcycle rear stand 100 is pivoted on pivots 112 and 114 in a clockwise direction as the rear stand 100 is seen in FIG. 8 and in a counterclockwise direction as the rear stand 100 is viewed in FIG. 9. As the upward movement of handle 126 progresses, pivot 112 is moved rearwardly towards pivot 114 to thereby raise side member 104 with respect to shorter side member 106 to thereby angle or tilt frame 102 and simultaneously lower bike engagement member 118 and its associated pin 120 toward the ground or lift surface G′ to the position shown in FIGS. 9 and 10. This movement causes the axis of bike engagement member pin 120 to become aligned with the axis CL′ of the bore of motorcycle rear wheel axle A′. When the axis of bike engagement member pin 120 is aligned with the center line CL′ of axle A′, the rear stand 100 is moved sideways to cause pin 120 to enter the bore of axle A′. Additionally, in this position, frame sides 104 and 106 are raised and angled with respect to lift surface G′ and the axis of pin 120 is parallel to the axes of pivots 112 and 114.

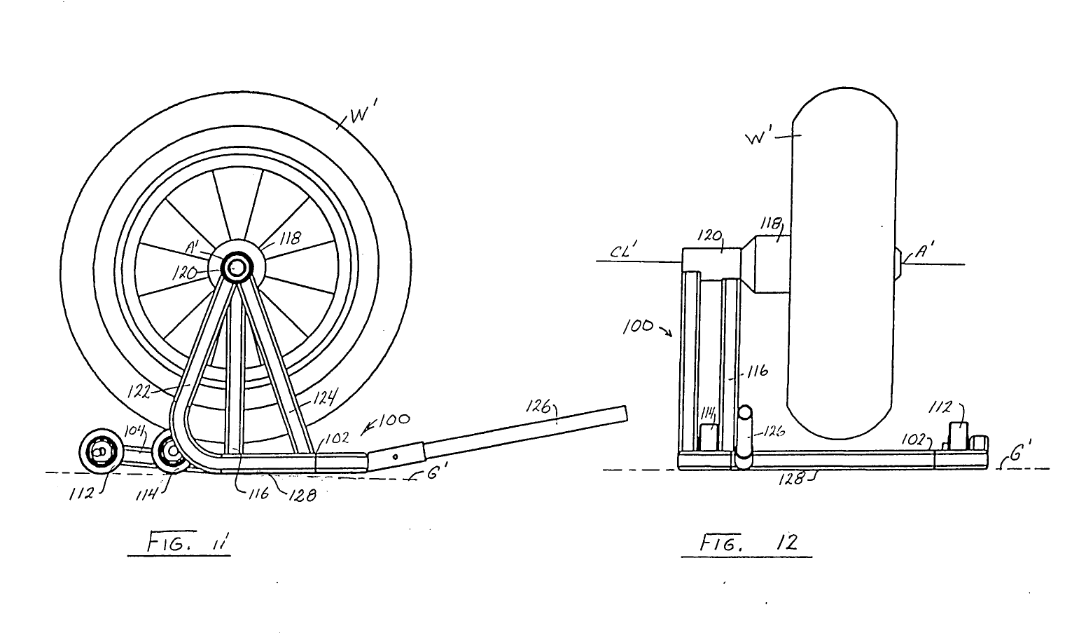

Thereafter, hand engagement member 126 is pivoted clockwise on pivots 112 and 114 from the upright position depicted in FIGS. 9 and 10 where the motorcycle rear wheel W′ is in the lowered position on ground G′ to a position in which frame stop surface 128 engages lift surface or ground G′ and the motorcycle rear wheel is in a lifted position as illustrated in FIGS. 11 and 12. As the rear portion of frame 102 is rotated clockwise, pivot 112 moves away from the rear of frame 112 and extends forwardly of pivot 114. As this occurs, frame side 104 is lowered and ultimately assumes a position in which it is parallel to side member 106 and to ground G′. Simultaneously, lift arm 116 and bike engagement member 118 are rotating clockwise to elevate rear wheel W′ to a lifted position. When rear wheel W′ is lifted and frame stop surface 128 engages the lift surface or ground G′, the center line CL′ of rear wheel axle A′ generally is parallel to the ground or lift surface G′, as depicted in FIG. 12. Also, in this position, pivot 112 and 114 are adjacent the ground or lift surface G′. Additionally, in this position, the axes of rear wheel axle A′ and bike engagement member 118 and pin 120 have moved over center such that the axes are between the axes of pivots 112 and 114 and stop surface 128. In other words, the weight of rear wheel W′ is directed downwardly to press stop surface 128 towards lift surface G′.

In order to return motorcycle rear wheel W′ to the lowered position depicted in FIGS. 9 and 10, hand engagement member 126 is rotated counterclockwise from the position shown in FIG. 11 to cause pivot 112 to move rearwardly towards pivot 114 to cause side arm 104 to be raised and frame 102 to become angled and the bike engagement member pin 120 to become aligned with angle of rear wheel axle A′ when the motorcycle is again supported by its kickstand.

I claim as my invention:

1: A motorcycle rear stand for lifting the rear end of a motorcycle having a rear end lift pivot member from a angled position with respect to a lift surface comprising:
a support frame having a pair of unequal length side members with proximal and distal ends and a lateral brace affixed to the proximal end of each side member;
a pivot affixed to the distal end of each side member;
a stop surface at the rear of said support frame;
a lift arm mounted at the front of said support frame and projecting upwardly therefrom having a bike engagement member mounted at the outer end thereof; and
said support frame movable between a motorcycle rear end lowered position in which the frame sides are raised from the lift surface and the bike engagement member pivot axis is angled to the lift surface and a motorcycle rear end lifted position in which the stop surface engages the lift surface, the frame sides are lowered to be adjacent the lift surface and the bike engagement member pivot axis is at a lifted elevation above the lift surface and substantially parallel to the lift surface.

2: The motorcycle rear stand of claim 1 in which said lift arm is mounted on said frame adjacent the shorter side member.

3: The motorcycle rear stand of claim 1 in which said bike engagement member pivot axis is parallel to the axis of said side member pivots.

4: The motorcycle rear stand of claim 1 further comprising a lateral reinforcing brace affixed to each of said frame side members.

5: The motorcycle rear stand of claim 1 further comprising a hand engagement member affixed to the rear end of said frame.

6: A motorcycle rear stand for lifting the rear end of a motorcycle having a rear end lift pivot member and supported by a kickstand which engages a lift surface and comprises:
a support frame having a pair of side members;
a stop surface at one end of said frame;
a first pivot on one side of said frame positioned forwardly of said stop surface a first distance;
a second pivot at the other side of said frame positioned forwardly of said stop surface a second distance;
a lift arm having inner and outer ends mounted on said frame and projecting upwardly therefrom;
a bike engagement member attached to the outer end of said lift arm;
said support frame being pivotal on said first and second pivots between a motorcycle rear end lowered position in which the side members are raised from the lift surface and said bike engagement member pivot axis is angled to the lift surface and at a lower elevation above said lift surface and a motorcycle rear end stabilized lifted position in which the frame sides are lowered to be adjacent the lift surface, the stop surface engages the lift surface and said bike engagement member pivot axis is at a lifted elevation above said lift surface and substantially parallel to said lift surface.

7: The motorcycle rear stand of claim 1 wherein said bike engagement member pivot axis is over center of said first and second pivots when said stand is in said stabilized lifted position.

8: The motorcycle rear stand of claim 1 further comprising a lateral support member attached to one end of each of said frame sides to form a frame having a generally U-shape.

9: The motorcycle rear stand of claim 1 in which the bike engagement pivot axis is positioned between said stop surface and the axes of said first and second pivots when said rear stand is in said motorcycle rear end stabilized lifted position.
